(19) United States
(12) Patent Application Publication
(10) Pub. No.: US 2020/0121557 A1
(43) Pub. Date: Apr. 23, 2020

(54) MEDICINE CONTAINER, HOUSING AND DISPLAY FOR MEDICINE CONTAINER

(71) Applicant: KONINKLIJKE PHILIPS N.V., EINDHOVEN (NL)

(72) Inventors: Doortje VAN DE WOUW, EINDHOVEN (NL); Maarten Marinus Johannes Wilhelmus VAN HERPEN, HEESCH (NL)

(21) Appl. No.: 16/371,884

(22) Filed: Apr. 1, 2019

Related U.S. Application Data
(62) Division of application No. 14/893,944, filed on Nov. 25, 2015, now abandoned.

(30) Foreign Application Priority Data
Jun. 14, 2013 (EP) 13172124.3

(51) Int. Cl. A61J 1/03; G09B 5/02; A61J 7/00

(52) U.S. Cl. CPC A61J 1/03; A61J 7/0084; G09B 5/02

(57) ABSTRACT

The present invention relates to a medicine container comprising a housing comprising a bottom wall and a plurality of sidewalls (12, 13, 22, 23) defining a plurality of compartments for each holding one or more medicine items (P) and a display arranged on one side of the bottom wall. To help a user, in particular a patient, in filling the medicine container the display is configured to visually display, per compartment and visual through the compartment, medicine filling information (F) indicating which medicine item to fill into the corresponding compartment.

### CROSS REFERENCE TO PRIOR APPLICATIONS

This application is a Divisional of application Ser. No. 14/893,944, filed on Nov. 25, 2015, which is the U.S. National Phase application under 35 U.S.C. § 371 of International Application No. PCT/EP2014/061791, filed on Jun. 6, 2014, which claims the benefit of European Patent Application No. 13172124.3, filed on Jun. 14, 2013. These applications are hereby incorporated by reference herein.

### FIELD OF THE INVENTION

The present invention relates to provide a medicine container, a housing and a display for use in such a medicine container. The present invention further relates to a method of controlling a display of such a medicine container and to a method of providing medicine filling information for use in such a medicine container. Finally, the present invention relates to a computer program for implementing said methods.

### BACKGROUND OF THE INVENTION

Many chronic patients have to take several medicine items a day (polypharmacy). As many medicine items have to be taken on different days and moments, the overview might get lost soon, especially for the older population or for people with mental disabilities. For this reason many patients use medicine containers, such as pill dispensers or pillboxes.

Many different medicine containers exist on the market. These medicine containers help patients in organizing the pills and sometimes in alerting them for the intake moment. A specific type of medicine container is the pill dispenser. These pill dispensers are often filled by a caregiver, and dispense pills at pre-determined times, often with a reminder to take the pill.

The known medicine containers vary in how much they take over responsibilities from the patient. In the context of current health care policies it is the aim to keep patient self-responsible for as much as possible, and stimulate patient self-management. Therefore (expensive) automatic pill dispensers are a last resort before having a (visiting) nurse managing the medication for the patient.

US 2010/332023 A1 discloses a medicine dispenser and method of reminding a user to take medicine. The medicine dispenser comprises a housing defining a plurality of compartment openings, each adapted to hold at least one medicine item and a plurality of covers. Each of the covers selectively closes one of the compartment openings to restrain access to the content of that compartment and provide access to the content of the respective compartment when opened. The medicine dispenser further includes a safety latch having first and second positions, wherein the safety latch inhibits opening of any of the covers when in its first position and allows opening of any of the covers when in its second position. When a user is reminded to take a medication, the position of the safety latch is monitored for an indication that the safety latch is moved from its first position to its second position. The user continues to receive the reminder until such indication is given.

US 2007/0135965 A1 discloses a system and method for storing items and tracking usage of items in a user configurable medication dispensing cabinet. Items are stored in a tray or drawer having user-adjustable storage spaces. A graphical user interface comprising a touch screen enables users to rapidly customize the layout of storage spaces, which allows a wide variety of shapes and sizes of items to be stored in the tray. A kit of items that are identified in advance may be removed more efficiently by ordering removal based on the location of the storage spaces in which the items are stored. Items not identified in advance may be removed and tracked more efficiently through the use of the graphical user interface or a scanner for reading machine-readable identification tags on the items or the storage spaces. Bar codes and RFID devices are contemplated for use as identification tags.

### SUMMARY OF THE INVENTION

It is an object of the present invention to provide a medicine container, a housing and a display for use in such a medicine container that help a user, in particular a patient or caregiver, in filling the medicine container.

It is another object of the present invention to provide a method of controlling a display of such a medicine container and to provide a method of providing medicine filling information for use in such a medicine container.

It is still another object of the present invention to provide a computer program for implementing said methods.

In a first aspect of the present invention a medicine container is presented comprising:

a housing comprising a bottom wall and a plurality of sidewalls defining a plurality of compartments for each holding one or more medicine items, and

a display arranged on one side of the bottom wall, said display being configured to visually display, per compartment and visual through the compartment, medicine filling information indicating which medicine item to fill into the corresponding compartment

In a further aspect of the present invention a housing for use in a medicine container is presented, said housing comprising a bottom wall and a plurality of sidewalls defining a plurality of compartments for each holding one or more medicine items and being configured for arranging a display on one side of the bottom wall, said display being configured to visually display, per compartment and visual through the compartment, medicine filling information indicating which medicine item to fill into the corresponding compartment.

In another aspect of the present invention a display for use in a medicine container is presented, said medicine container comprising a housing comprising a bottom wall and a plurality of sidewalls defining a plurality of compartments for each holding one or more medicine items, said display being configured for being arranged on one side of the bottom wall and to visually display, per compartment and visual through the compartment, medicine filling information indicating which medicine item to fill into the corresponding compartment.

In another aspect of the present invention a method for controlling a display of a medicine container is presented, said medicine container comprising a housing comprising a bottom wall and a plurality of sidewalls defining a plurality of compartments for each holding one or more medicine items, said display being configured for being arranged on one side of the bottom wall, said method comprising the step of controlling the display to display, per compartment and visual through the compartment, medicine filling information indicating which medicine item to fill into the corresponding compartment.

In yet another aspect of the present invention a method of providing medicine filling information is presented, said medicine filling information indicating which medicine item to fill into the corresponding compartment of a medicine container as claimed in claim 1, said method comprising the steps

receiving dispenser information indicating the type of medicine container,

receiving the medication scheme of the patient using the medicine container,

generating said medicine filling information from said dispenser information and said medication scheme,

providing said medicine filling information to the patient and/or the medicine container for preparing or controlling said display.

In yet further aspects of the present invention, there are provided a computer program which comprises program code means for causing a computer to perform the steps of the processing method when said computer program is carried out on a computer, in particular an electronic display, as well as a non-transitory computer-readable recording medium that stores therein a computer program product, which, when executed by a processor, in particular an electronic display, causes the method disclosed herein to be performed.

Preferred embodiments of the invention are defined in the dependent claims. It shall be understood that the claimed housing, display methods, computer program and medium have similar and/or identical preferred embodiments as the claimed medicine container and as defined in the dependent claims.

The known medicine containers, such as known pillboxes and pill dispensers, focus on storing and giving reminders to take a certain pill. Often professional or informal caregivers have to help the patient to fill the container, which is very costly, especially regarding the extreme growth of this group of people. The known medicine containers thus miss the relevant aspect of helping the users, in particular the patients, to fill the container themselves so that they can keep their autonomy. Currently, patients often have to rely on family, friends or professional caregivers for this task or have to develop their own methodology, take away too much autonomy from the people and are very expensive.

The present invention is thus based on the idea to overcome these deficiencies by using medicine filling information indicating which medicine item to fill into the corresponding compartment formed within the housing for placing one or more medicine items therein. This medicine filling information is displayed to the user of the medicine container such that the user can easily and unambiguously recognize and understand which medicine item to put into which compartment, which is achieved by arranging the display on one side of the bottom wall of the housing so that the user can see the displayed medicine filling information through the respective compartments and can thus directly place the medical item into the compartment, more or less “on top of” the displayed medicine filling information.

Thus, a simple and inexpensive, but effective way of helping users, in particular patients, to fill the medicine container is provided, which keeps the autonomy of the user.

In a quite cheap and simple embodiment the display is formed as (personalized) medication card or (personalized) booklet of several medication cards. These medication cards instruct the patient how to fill the medicine container according to a predetermined filling scheme. The medication card or booklet is preferably generated (in particular printed) by a physician, a specialist or a pharmacist of the patient and is then handed over or sent via mail to the patient. Alternatively, the data for generating the medication card or booklet are sent to the patient, e.g. via an email or via a download link or by use of a data carrier (e.g. CD-ROM) sent to the patient via mail, so that the patient can generate (in particular print) the medication card or booklet by himself.

In another preferred embodiment the display is formed as electronic display, in particular as smartphone, PDA or tablet computer. On the screen of such an electronic display the medicine filling information is depicted electronically, e.g. under control of a corresponding control method implemented as computer program (e.g. an application software; app). The medicine filling information is preferably delivered electronically to the electronic display from a physician or a pharmacist, which may just be some raw data used by the computer program to generate and control the displayed information on the screen.

In a preferred embodiment said display is configured to display medicine filling information comprising text and/or picture information of the medicine items and/or of the package of the medicine items to fill into the corresponding compartments. Since pills often look very similar or even identical, it is preferred to display both text (e.g. the brand name) and an image of the medicine item, or even the package of the medicine item so that the medicine item is uniquely identified and confusions are avoided.

In another preferred embodiment said bottom wall is transparent and said display is arranged on the side of the bottom wall opposite the plurality of sidewalls, wherein said medicine filling information is displayed in the direction of the transparent bottom wall. The user can thus see the medicine filling information through the compartments and through the transparent bottom wall of the housing. The display can thus be easily exchanged.

In an alternative embodiment that does not require the bottom side wall of the housing to be transparent the housing comprises a display compartment arranged between the plurality of sidewalls and the bottom wall or within said plurality of sidewalls transversal to them, wherein said display is arranged within said display compartment. Said display compartment may e.g. be configured as a slit within the housing between the sidewalls and the bottom wall into which the display can be inserted. This embodiment provides a better view on medicine items on the display, a better re-checking for releasing and does not require for the housing, in particular the bottom wall to be transparent.

Preferably, said display is arranged removably at or within the housing. This is particularly necessary in case of using medication cards as display, but also in case of using an electronic display this may be advantageous since the display, e.g. a tablet computer, can then be used also for other purposes.

For better holding and adjustment of the position of the display with respect to the housing appropriate visual and/or mechanical placement indicators may be provided for indicating and/or supporting correct placement of the display with respect to the housing. These indicators are preferably provided on the bottom surface of the bottom wall. In another embodiment a slit, as mechanical placement indicator, is provided for receiving the display.

In an advantageous embodiment said display and/or said housing further comprises identification means for identifying the moment of placement and/or removal of the display, the orientation of the display with respect to the housing and/or the patient using the medicine container. By use of such means, which are preferably used if the display is an electronic display, a filling operation can be automatically started and the accuracy of the display of the medicine filling information can be increased. Further, the orientation and location of the housing (e.g. upside down, top left corner of screen, etc.) can be determined. This is important as the display indication only works if the medicine filling information is exactly below the right compartment.

Such identification means may be implemented in various ways, in particular comprises one or more of electrically conductive elements, capacitive elements, a pressure element, an RFID element, a near-field communication element, a barcode, a QR code and/or a predetermined shape and/or color of at least part of the housing. In other embodiments said identification means comprises electrically conductive holding elements arranged at an outer sidewall of the housing and identification markers electrically coupled to said holding elements and arranged at the bottom wall on the side facing the display such that they contact the display. This is particularly useful if the display comprises a capacitive screen, as many tablet computers have. If the user's finger touches one holding element this can be recognized by the capacitive screen and will be interpreted such that the display has been combined with the housing. The display may then automatically switch into a filling mode operation mode, e.g. to a particular software application (“app”) that guides the user through the whole filling process. For this purpose the display is configured in an embodiment to display guidance information guiding a user of the medicine container which steps to carry out to fill the medicine container.

In an alternative embodiment said identification means comprises capacitive identification markers arranged at the bottom wall on the side facing the display such that they contact the display. Thus, even if the user's finger does not touch an electrically conductive holding element or if no such electrically conductive holding elements are provided, it can be recognized by the capacitive screen if the display has been coupled with the housing.

While the medication cards as display need to be printed or generated in some way, in case of using an electronic display the medicine filling information is generally provided in electronic form. For this purpose the medicine container further preferably comprises an interface coupled to the display for receiving said medicine filling information, in particular from a pharmacy, physician, caregiver or medical database holding information on the medication scheme of the patient using said medicine container. Said interface may be an analog or digital, wired or wireless interface, e.g. a drive for receiving a data carrier (e.g. a CD-ROM, DVD, BD), a slot for receiving a semiconductor memory element (e.g. a USB-stick or memory stick), a LAN or WLAN interface, etc. The medicine filling information may then be provided as electronic data file transferred electronically, e.g. on a data carrier, attached to an email, provided for download, etc.

### BRIEF DESCRIPTION OF THE DRAWINGS

These and other aspects of the invention will be apparent from and elucidated with reference to the embodiment(s) described hereinafter. In the following drawings

FIG. 1 shows a cross sectional view of a first embodiment of a medicine container according to the present invention,

FIG. 2 shows a cross sectional view of a second embodiment of a medicine container according to the present invention,

FIGS. 3A, 3B and 3C show perspective views of various states of the second embodiment of the medicine container,

FIG. 4 shows a cross sectional view of a third embodiment of a medicine container according to the present invention,

FIGS. 5A, 5B and 5C show top views of various states of a fourth embodiment of a medicine container according to the present invention,

FIG. 6 shows a top view of the first embodiment of a medicine container illustrating the use of a medication card,

FIG. 7 shows an embodiment of a booklet of several medication cards,

FIGS. 8A and 8B show top and side views of a fifth embodiment of a medicine container according to the present invention,

FIG. 9 shows a cross sectional view of a sixth embodiment of a medicine container according to the present invention,

FIG. 10 shows a cross sectional view of a seventh embodiment of a medicine container according to the present invention,

FIG. 11 shows a top view onto the bottom wall of the housing 70 of the embodiment of the medicine container shown in FIG. 10,

FIGS. 12A and 12B show different views of an eighth embodiment of a medicine container according to the present invention, and

FIGS. 13A through 13G illustrate the steps of a method according to the present invention.

### DETAILED DESCRIPTION OF THE INVENTION

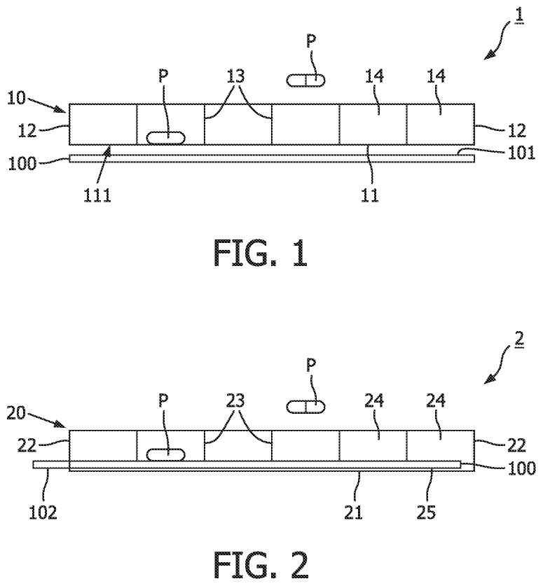

FIG. 1 shows a cross sectional view of a first embodiment of a medicine container 1 according to the present invention. The medicine container 1 comprises a housing 10 comprising a bottom wall 11 and a plurality of sidewalls, in particular inner sidewalls 12 and outer sidewalls 13, defining a plurality of compartments 14 for each holding one or more medicine items P, e.g. pills, capsules, powder, etc. The medicine container 10 further comprises a display 100 arranged on one side of the bottom wall 11, in this embodiment on the outer surface 111 of the bottom wall 11 opposite the plurality of sidewalls 12, 13. Said display 100 is configured for visually displaying, per compartment 14 and visual through the compartment 14, medicine filling information indicating which medicine item P to fill into the corresponding compartment 14.

In an inexpensive implementation of the first embodiment of the medicine container 1 the housing 10 is formed as a pillbox having a transparent bottom wall 11 and the display 100 is formed as a patient-individual medication card carrying the medicine filling information, e.g. printed on the top surface 101 of the medication card. Thus, the medicine filling information is displayed in the direction of the transparent bottom wall 11 and can be seen by the user from above through the compartments 14. The medication card preferably has a size that is adapted to fit exactly below the housing 10 as shown in FIG. 1.

The medicine filling information preferably comprises text and/or picture information of the medicine items P and/or of the package of the medicine items P to fill into the corresponding compartments 14. For instance, if a certain pill against hypertension shall be filled into a particular compartment 14 shall be filled, a picture of this pill and/or its brand name and/or a picture of its package (e.g. if several medicine items to be filled into the container look very similar, as is often the case) may be shown on the medication card in the field that is directly arranged below said compartment.

FIG. 2 shows a cross sectional view of a second embodiment of a medicine container 2 according to the present invention. In this embodiment the housing 20 comprises a slot 25 (or, more generally, a display compartment) that is arranged between the plurality of sidewalls 22, 23 forming the compartments 24 and the bottom wall 21. The display 100, which is again preferably designed in form of a medication card, is arranged within said slot 25.

This embodiment avoids the problem that may exist with the first embodiment that the user places the display 100 below the housing 10 in the wrong orientation (turned by 180°), which might result in a wrong filling of the medicine container. This can be prevented by the second embodiment if the display 100 can only be placed into the slot 25 in one way and into which the display 100 exactly fits. Preferably, the display 100 comprises a tab 102 on the side that is closest to the opening of the slot 25, which supports the user to easily place and remove the display 100. Further, the housing 20 is at least partially transparent, to enable the display 100 to be at least partially visible through the housing 20. The compartments 24 are completely formed above the slot 25

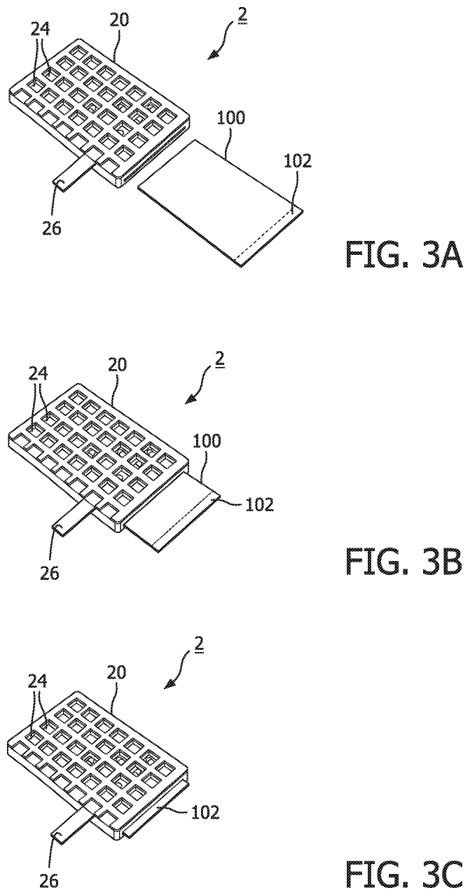

FIGS. 3A, 3B and 3C show perspective views of various states of the second embodiment of the medicine container 20. In particular, FIG. 3A shows the display 100 (e.g. a medication card) separate from the housing 20. FIG. 3B shows the display 100 partly introduced into the slot 25. FIG. 3C shows the display 100 completely introduced into the slot 25 with only the tab 102 projecting out of the slot 25. As shown in FIGS. 3A, 3B and 3C as well, the compartments 24 are covered by caps 26 which may be pull laterally to open and close one or more compartments 24 to fill in or remove medicine items P.

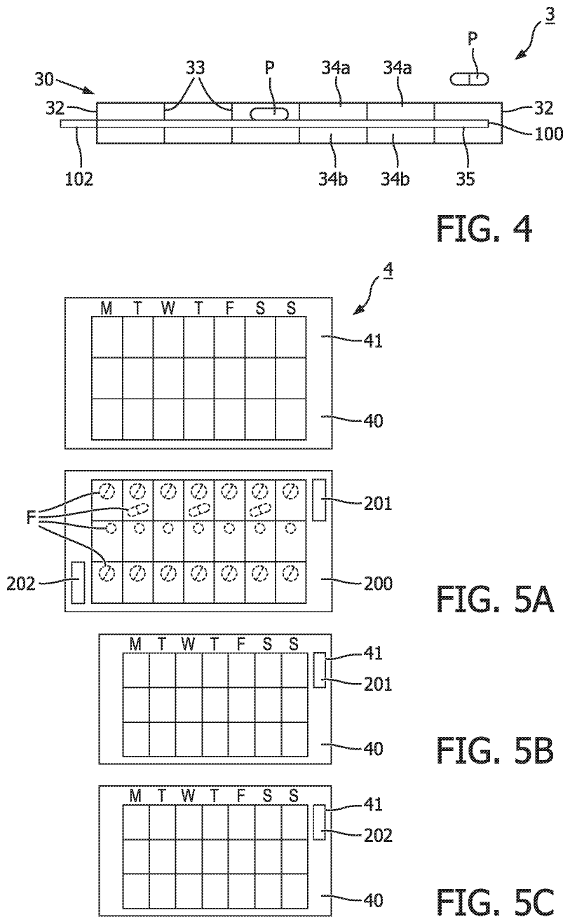

FIG. 4 shows a cross sectional view of a third embodiment of a medicine container 3 according to the present invention. Different from the second embodiment shown in FIG. 2, in this embodiment the housing 30 comprises a slot 35 (or, more generally, a display compartment) that is arranged between the plurality of sidewalls 32, 33 transversal to them, i.e. the compartments are split into sub-compartments 34a formed above the slot 35 and sub-compartments 34b formed below the slot 35. When the display 100 is placed inside the slot 35 and the medicine items P are filled in, they are placed in the upper sub-compartment. If the filling process is finished the display 100 is removed from the slot 35 so that the medicine items P fall into the lower sub-compartments 34b so that, depending on their size, they are only placed in the lower sub-compartments 34b or in the upper and lower sub-compartments 34a, 34b.

This embodiment provides the possibility for doing a final check before releasing the medicine items P into the compartments (i.e. before removing the display from the slot 35), so that mistakes are hardly possible anymore. Further, a better visibility onto the display is achieved, in particular when some of the medicine items P are already filled (e.g. by use of a first medication card) into the lower sub-compartments, i.e. they do not block the view onto the medicine filling information (e.g. of a subsequently used second medication card) for other compartments. Still further, this solution does not require the housing 30 to be transparent. Another benefit of this embodiment is that it allows the user to get a new medication card in between the filling process without getting confused. Next to that it does also not require the box to be transparent. Further, this embodiment will provide advantages if a lot of (e.g. different) medicine items need to be filled into the medicine container. In this case it is preferred that a medication card shows only one medicine item per medication card. Finally, in this embodiment the housing (in particular the bottom sidewall) does not need to be transparent.

FIGS. 5A, 5B and 5C show a top view of various states of a fourth embodiment of a medicine container 4 according to the present invention. In this embodiment the display 200, which is preferably formed as medication card again, comprises a code for correct placement with respect to the housing 40. FIG. 5A shows the housing 40 separate from the medication card 200. The medication card 200 comprises a code fields 201, 202, here formed as fields of different color (e.g. field 201 as green field, field 202 as red field). But other codes such as word (“ok” and “wrong”), different hatchings, etc. may be used as code fields to indicate if the medication card is correctly or wrongly placed. The medication card 200 further shows medicine filling information F, here mainly in the form of pictures showing the medicine items to fill into the respective compartments.

The housing 400 comprises a (transparent) window 401 through which the respective code field 201, 202 is visible when the medication card 200 is placed under (as e.g. for the first embodiment of the medicine container) or inside (as e.g. for the second or third embodiment of the medicine container) the housing 400. FIG. 5B shows the state of the medicine container 4 in which the medication card 200 is correctly placed with respect to the housing 400 so that the code field 201 (e.g. a green field indicating correct placement) is visible through the window 401. FIG. 5C shows the state of the medicine container 4 in which the medication card 200 is incorrectly placed with respect to the housing 400 so that the code field 202 (e.g. a red field indicating incorrect placement) is visible through the window 401.

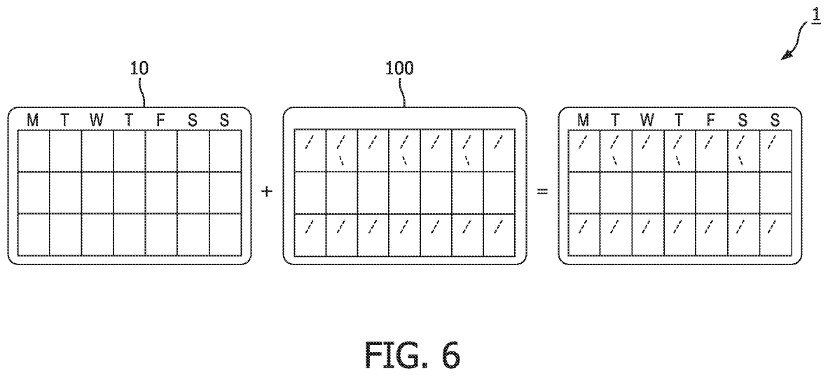

FIG. 6 shows a top view of the first embodiment of a medicine container 1 illustrating the use of a medication card 100. Together with the doctor, specialist, pharmacy and/or informal caregiver the medication scheme will be customized per patient (user). The medication card 100 can then be printed by the doctor, specialist, pharmacy, informal caregiver or the patient (user) himself (e.g. in case a digital health system is used). When the medication scheme changes the medication card will be adapted and newly printed. In the embodiment of the medication card 100 shown in FIG. 6 the full medication overview is visible on one medication (overview) card.

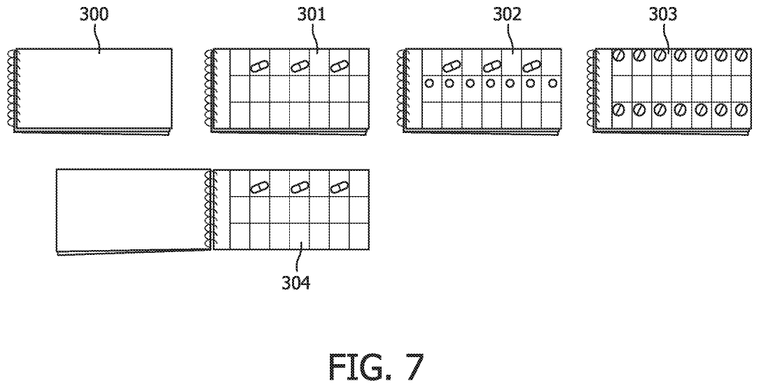

FIG. 7 shows an embodiment of a booklet 300 of several medication cards 301, 302, 303, 304. If a patient has a more complex medication scheme (e.g. more pills, more moments or less consistent over the days) such a booklet 300 of several medication cards can be given, wherein each medication card of the booklet may be provided for a different medicine item.

Thus, in a practical implementation of such a booklet 300 every medicine has its own medication card. The front of the booklet 300 clearly mentions the name of the patient, to who the booklet belongs. The medication cards are placed in the most convenient sequence for filling: the least amount of medicine items first, so that the medicine items do not hide the view on the medication cards for the later fillings. A ring band can be added to the side, so that the different medication cards are kept in the right sequence and that they can be easily put to the front. The booklet 300 can be used in combination with housings according to all embodiments shown above, i.e. with housings where the medication card is put below or with housings having a slot.

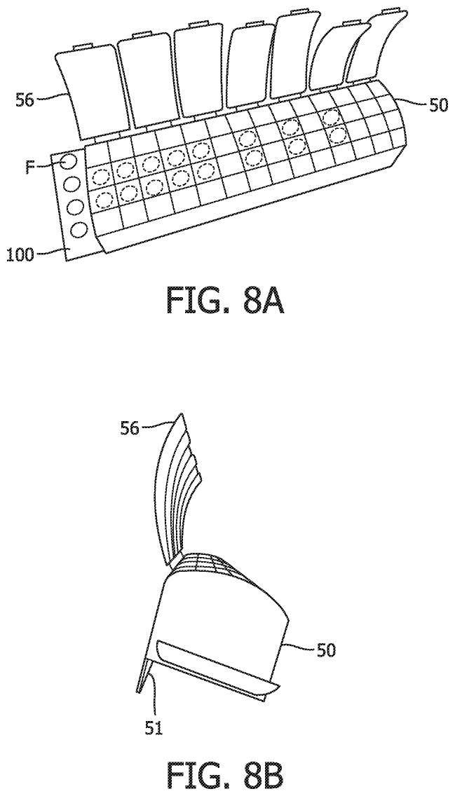

FIG. 8A shows a top view and FIG. 8B shows a side view of a fifth embodiment of a medicine container 5 according to the present invention. The medication card 100 is inserted below the transparent housing 50, i.e. below the compartments 54 which can be covered by caps 56, and can show the whole filling regime at once, or show them step by step (e.g. per medicine item). To ensure the medicine items on the medication card 100 stay visible, also when some medicine items are already inserted in the medicine container 5. For that reason the housing 50 is configured (e.g. by use of a protrusion 51 or support leg) such that it is placed under an angle as shown in FIG. 8B and/or the bottom walls inside the compartments are inclined accordingly to achieve this effect. Further, the medicine filling information F is preferably depicted in the top corner of each compartment 54.

While in the above explained embodiments the display is formed as medication card or booklet of several medication cards, in the following embodiments the display is formed as electronic display, in particular as smartphone, PDA or tablet computer.

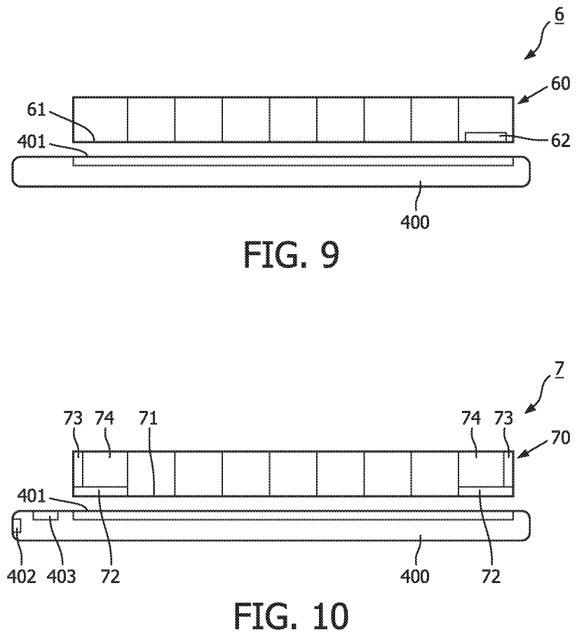

FIG. 9 shows a cross sectional view of a sixth embodiment of a medicine container 6 according to the present invention. The medicine container 6 comprises a housing 60 and an electronic display 400, in this embodiment a tablet computer having a screen 401. The size of the housing 60 is adapted to fit with the screen 401. For identification of the moment of placement and/or the orientation of the housing 60 with respect to the display identification means 62 is provided within the bottom wall 61 of the housing 60. The housing 60 is at least partially light transmissive to enable to display apparatus 400 to be at least partially visible through the housing 60.

FIG. 10 shows a cross sectional view of a seventh embodiment of a medicine container 7 according to the present invention. A problem with identification on a capacitive screen, as often provided in electronic displays, such as tablet computers, is that a capacitive screen will normally not recognize the housing, because the capacitive electrical properties do not match those of a human finger. A solution is to electrically connect the housing 70 to the human finger, as is shown in FIG. 10. In this embodiment the outer sidewalls 73 of the housing are electrically conductive, e.g. by arranging electrically conductive elements 74 at the outer sidewalls or representing the outer sidewalls. The electrically conductive part 74 is connected to identification markers 72 arranged at or within the bottom wall 71 of the housing 70. When a person is holding the housing 70, the electrical conductive layer 74 is touched by the hands of the person. The capacitive display 400 will then recognize the housing 70 when it is placed on the screen 401, and thus it is detected when the housing 70 is placed on top of the display 400.

Thus, when keeping contact with the human body, a capacitive material may be used to connect the part that is touched by hand (i.e. the conductive layer 74) to the ‘feet’ of the housing (i.e. the identification markers). In an embodiment the capacitive material (e.g. copper) representing the layer 74 is provided on all sides of the housing.

By another instance, e.g. the GP (General Practitioner), doctor, specialist and/or pharmacy, the medication scheme and the medicine filling information is generally customized per patient and can be automatically updated if needed, e.g. after a doctor's visit. To provide the updated medicine filling information to the display 400 an interface 402 is preferably coupled to the display 400 for receiving said medicine filling information, in particular from a pharmacy, physician, caregiver or medical database holding information on the medication scheme of the patient using said medicine container. The interface 402 may be configured as communication (or data transmission) interface for wireless or wired reception (and preferably transmission) of information, e.g. as LAN, WLAN, Bluetooth interface. In other embodiments the interface 402 may be configured interface for reading a data carrier, e.g. as USB interface, CD drive, etc. Further embodiments enabling the reception of medicine filling information in electronic form may be used as well. It is also possible in an embodiment that a warning is sent to the display (and is displayed there) indicating to the patient that the medication scheme has been updated and a new version of medicine filling information is available.

For automatic recognition of the type of medicine item appropriate recognition means, e.g. a camera 403 as often provided as standard equipment in table computers, are preferably provided. The use of such recognition means will be explained in more detail below.

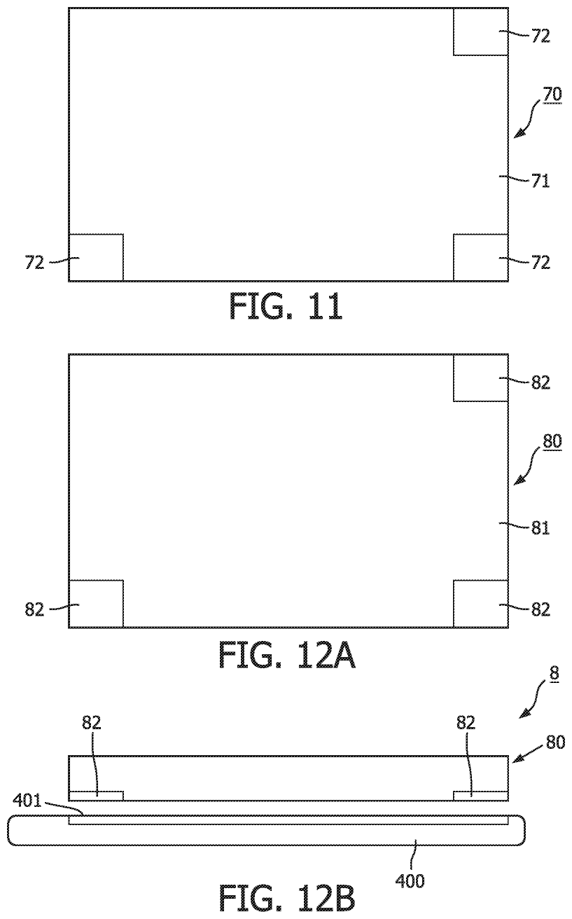

FIG. 11 shows a top view onto the bottom wall 71 of the housing 70 shown in FIG. 10. In particular, an embodiment of a pattern of identification markers 72 (e.g. two cupper strokes that create enough mass) is shown, which can be used to detect the position and orientation of the housing 70 as it has three connection points to the display.

Even further, in another embodiment, if not connected to the human body, the identification markers 72 (i.e. the capacitive material) needs mass from itself. A copper stroke connecting the three feet (i.e. provided on two sides) can provide this. With these two copper strokes enough mass is created to detect the three feet on the digital display without the connection to a human body. The identification means 72 then, however, need to imitate the capacity of the human body part usually touching the capacitive display.

A potential problem with the seventh embodiment of the medicine container 7 is that, when the user stops touching the housing 70, the housing 70 is no longer detected. This means the housing 70 may move or be removed without being detected. A solution is to use capacitive identification means 82 (provided on the bottom surface 81) that does not need to be touched by a human body part. FIG. 12B shows a cross sectional view of an eighth embodiment of a medicine container 8 and FIG. 12A shows a top view onto the bottom wall 81 of its housing 80 according to the present invention employing this idea. The capacitive identification means 82 simulates the capacitive properties of the human finger. Such capacitive identification means are generally known and are e.g. used in a capacitive stylus provided for use in combination with a tablet computer.

There exist various further embodiments of identification means that can be used in the housing 70 or 80 instead of or in addition to the identification means 72, 82. In particular one or more of the following embodiments may be used:

an electrically conductive pattern connected to the sidewalls of the housing (e.g. for use in combination with a capacitive display);

a capacitive identification pattern (e.g. for use in combination with a capacitive display);

a pressure point (e.g. for use in combination with a pressure sensitive display);

an RFID chip (e.g. for use in combination with a display that further comprises an RFID detector);

a near-field-communication chip (e.g. for use in combination with a display that is enabled with near-field-communication);

a QR code (e.g. for use in combination with a display that further comprises a camera and wherein the housing is configured such that the QR code can be read only when the housing is placed on the display correctly);

a specific shape and/or color of the housing or part of the housing (e.g. for use in combination with a display that further comprises a camera and wherein the housing is configured such that identification means can be viewed by the camera when the housing is placed on the display correctly).

The above mentioned identification means are used to see if the housing is placed on top of the display and to identify the orientation, presence and location of it. Another identification means can be added to identify which person has logged in to the system. This can be a similar type of identification, e.g. an RFID chip, a near-field-communication chip, a QR code or a specific shape and/or color of the housing or part of it. When using such personal identification means, different persons can use the same display, which will automatically show the right medication scheme and the right medicine filling information for the current user.

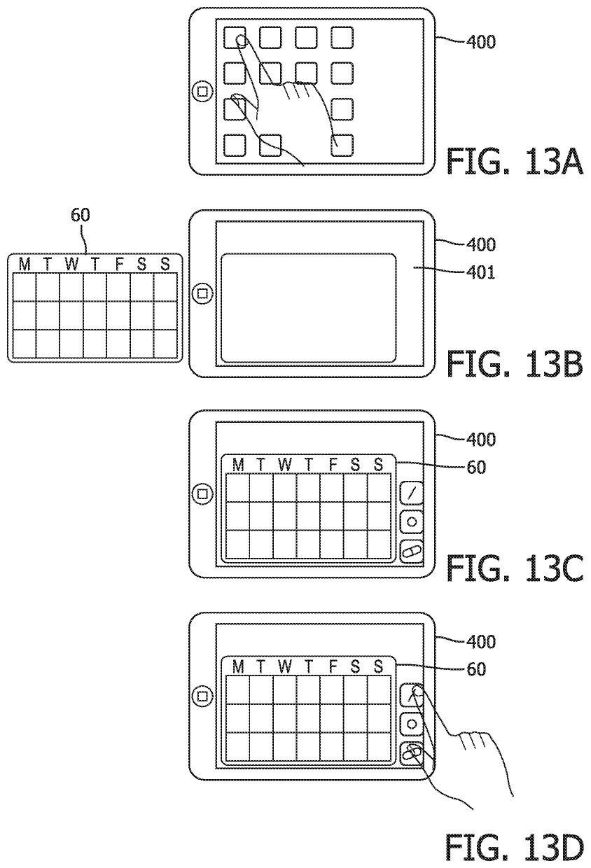

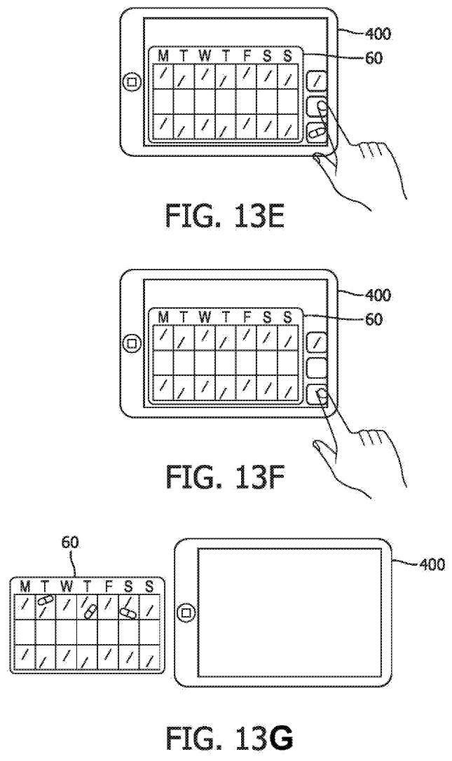

In a preferred embodiment a software application or computer program is preferably installed to control the display and show the medicine filling information on the display or even guide the user through a process of filling the medicine container. An exemplary embodiment of such a guiding process is illustrated in FIGS. 13A through 13G (using the sixth embodiment of the medicine container 6 as shown in FIG. 9 for this illustration).

The application is opened on the display 400 (FIG. 13A) and will ask the patient to put the housing 60 on the screen 401 of the display 400 (FIG. 13B). By detecting the identification means, the display 400 can identify if the housing 60 is placed and in which orientation. By detecting the personification means (as explained above), the display 400 can identify who's housing 60 is placed on the display 400 (in case more patients want to use the same application and the same display). It will open the personal medication overview (FIG. 13C) and the patient can indicate which medicine item he/she would like to start filling. The display 400 will highlight the fields of the housing 60 that need to be filled with the selected medicine item, which will be visible by the user as the housing 60 is semi-transparent (FIG. 13D). After filling the other medicine items can be selected for filling (FIGS. 13E and 13F). In the end the housing 60 is correctly filled and can be taken from the display (FIG. 13G).

As in a preferred embodiment the housing is detected, it is further preferred that the area illuminated on the screen of the display 400 where to place the housing 60 will move with the housing 60, if it is moved by purpose or accident.

In the end of the filling procedure the user might encounter that he needs to order new medicine items for the current or the next filling procedure. As the display is personal and has a direct connection to the medication providers, new medication can be ordered automatically, e.g. by a press on a particular (software) button provided for this purpose.

In a further embodiment means for automatic recognition of the type of medicine item are provided (e.g. a camera 403 as shown in FIG. 10). Depending on the mental abilities of the patient, additional support can be given in such recognition. For instance, instead of clicking on one of the shown medicine items on the display 400 (as shown in FIGS. 13D-13F), the patient can also hold the medicine item or its package in front of the camera, which will automatically select the shown medicine item on the display for filling next. This can be done by one or several of the following techniques:

the barcode on the package of the medicine item;

an RFID chip (e.g. for use in combination with a display that further comprises an RFID detector);

a near-field-communication chip (e.g. for use in combination with a display that is enabled with near-field-communication);

a QR code (e.g. for use in combination with a display that further comprises a camera, wherein the housing is configured such that the QR code can be read only when the housing is placed on the display correctly);

a specific shape and/or color of the housing or part of the housing (e.g. for use in combination with a display that further comprises a camera, wherein the housing is configured such that identification means can be viewed by the camera when the housing is placed on the display correctly).

In an embodiment the software application preferably comes with all medication information (including the medicine filling information) included (e.g. sent by pharmacy/doctor), or the patient or his care providers can insert this in first instance.

The present invention can be implemented in various ways. In the above explained embodiments the housing is preferably implemented as a (simple and cheap) pillbox. In other embodiments the housing may be provided with more functionalities, such as means for automatic recognition if a medicine item has been taken out of the compartment by the patient, means for reminding the patient when to take out which medicine item, etc. For instance, the compartments can all have small weight scales to detect if a medicine item is placed in the right compartment and deactivate the light below that compartment in that case. Also when the patient wants to continue filling another type of medicine item, while the former medicine item was not filled correctly, an alarm can be given to the patient, caregiver or doctor (if not solved/changed in the end), e.g. through a communication interface (402 in FIG. 10). The housing may, for instance, be implemented as a pill dispenser, e.g. including electronics and control means, for enabling such additional functionalities.

The proposed invention can advantageously be applied to support patients, e.g. elder persons, at home and will help patients in filling the medicine container on their own and thus to stay/be more independent, which is an important issue for people that become older. Further, the proposed invention does also make it easier for other users, e.g. caregivers, that help the patient filling the medicine container.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. An electronic display for use with a medicine container comprising a housing with a transparent bottom wall and a plurality of sidewalls defining a plurality of compartments for each holding one or more medicine items,
wherein said electronic display is arrangeable on one side of the transparent bottom wall, and;
wherein said electronic display visually displays, through each individual compartment of the plurality of compartments, medicine filling information indicating which medicine item to fill into the individual compartment.

2. The display for use with a medicine container of claim 1, wherein the electronic display is selected from a group consisting of: a smartphone, a personal digital assistant (“PDA”), or a tablet computer.

3. The display for use with a medicine container of claim 1, further comprising an interface coupled to the display for receiving said medicine filling information from an external source.

4. The display for use with a medicine container of claim 3, wherein the external source is selected from a group consisting of: a pharmacy, a physician, a caregiver, or a medical database holding information on said medicine filling information of a patient using said medicine container.

5. The display for use with a medicine container of claim 1, wherein the electronic display displays guidance information guiding a user of the medicine container which steps to carry out to fill the medicine container.

6. The display for use with a medicine container of claim 1, wherein the electronic display identifies an orientation of the electronic display with respect to the housing based on an identifier associated with the housing.

7. The display for use with a medicine container of claim 6, wherein the identifier comprises at least one of the group including: a barcode, a quick response (“QR”) code, or a predetermined shape or color of at least part of the housing.

8. A medicine container comprising:
a housing comprising a transparent bottom wall, a plurality of sidewalls arranged laterally from the bottom wall to define a plurality of compartments for each holding one or more medicine items; and
one or more visual or mechanical placement indicators for indicating or supporting correct placement of an electronic display with respect to the housing;
wherein detection of one or more visual or mechanical placement indicators by said electronic display causes said electronic display to visually render, through the transparent bottom wall, medicine filling information indicating which of the one or more medicine items to fill into each of the plurality of compartments.

9. The medicine container of claim 8, wherein the one or more of the visual or mechanical placement indicators is used by the electronic display for identifying a moment of placement or removal of the electronic display.

10. The medicine container of claim 9, wherein one or more of the visual or mechanical placement indicators is used by the electronic display to identify an orientation of the electronic display with respect to the housing.

11. The medicine container of claim 9, wherein the one or more visual or mechanical placement indicators include at least one of the group including: electrically conductive elements, capacitive elements, a pressure element, a radio frequency identification (“RFID”) element, a near-field communication element, a barcode, a quick response (“QR”) code and a predetermined shape or color of at least part of the housing.

12. The medicine container of claim 8, wherein the electronic display is selected from a group consisting of: a smartphone, a PDA, and a tablet computer.

13. A method comprising:
providing a medicine container comprising a housing, wherein the housing includes a bottom wall and a plurality of sidewalls defining a plurality of compartments for each holding one or more medicine items;
arranging an electronic display on one side of the bottom wall; and
causing the electronic display to visually render, through each individual compartment of the plurality of compartments, medicine filling information indicating which medicine item to fill into the individual compartment.

14. The method of claim 13, further comprising displaying guidance information on the electronic display that guides a user of the medicine container which steps to carry out to fill the medicine container.

15. The method of claim 13, wherein the electronic display is selected from a group consisting of: a smartphone, a personal digital assistant (“PDA”), or a tablet computer.

16. The method of claim 13, further comprising receiving, via an interface coupled to the electronic display, the medicine filling information from an external source.

17. The method of claim 16, wherein the external source is selected from a group consisting of: a pharmacy, a physician, a caregiver, or a medical database holding information on said medicine filling information of a patient using said medicine container.

18. The method of claim 13, further comprising identifying an orientation of the electronic display with respect to the housing based on an identifier associated with the housing.

19. The method of claim 18, wherein the identifier comprises at least one of: a barcode, a quick response (“QR”) code, a predetermined shape of at least part of the housing, or a color of at least part of the housing.

20. The method of claim 18, wherein the identifier comprises at least one of: an electrically conductive element, a capacitive element, a pressure element, a radio frequency identification (“RFID”) element, or a near-field communication (“NFC”) element.
